(19) United States
(12) Patent Application Publication
(10) Pub. No.: US 2004/0217939 A1
(43) Pub. Date: Nov. 4, 2004

(54) Changing the visual appearance of input devices

(75) Inventors: David H. Levy, Cambridge, MA (US); Christopher B. Hare, Williamsburg, VA (US)

Correspondence Address: FISH & RICHARDSON PC, 225 FRANKLIN ST, BOSTON, MA, 02110, US

(73) Assignee: Digit Wireless, LLC, a Delaware corporation

(21) Appl. No.: 10/785,659

(22) Filed: Feb. 24, 2004

Related U.S. Application Data
(63) Continuation of application No. PCT/US02/27131, filed on Aug. 26, 2002.
(60) Provisional application No. 60/315,001, filed on Aug. 24, 2001.
(60) Provisional application No. 60/351,939, filed on Jan. 25, 2002.

(51) Int. Cl. G09G 5/00

(52) U.S. Cl. 345/156

(57) ABSTRACT

Keycaps of a keypad or regions of a digitizer contain an electrophoretic ink. An electric field is passed through selected regions of the ink to form a desired graphic label visible at the exposed surface of the keycap or region. In some cases, conductors within the keypad or digitizer alter the ink. In other cases, the keycaps or regions are placed proximate a printer that alters the ink, such as to initialize a generic keypad for a given function. A keypad contains a MOD key to cycle between language-specific variants of a last-entered character. In some cases, the keys are altered remotely to change their displays, such as to update subscriber service information or advertising.

### RELATED APPLICATIONS

This application is a continuation of PCT Application No. PCT/US02/27131, filed Aug. 26, 2002 designating the United States and claiming the benefit of the filing dates of U.S. Provisional applications 60/315,001 filed Aug. 24, 2001, and 60/351,939 filed on Jan. 25, 2002, respectively. The entire contents of these priority applications are hereby incorporated herein by reference.

### TECHNICAL FIELD

This invention relates generally to keypads and other input devices.

### BACKGROUND

As electronic products become smaller and more sophisticated, the value of product “real-estate” climbs higher and higher. Accordingly, the value of adaptive input technologies (e.g., stylus input devices, touch screens, touch pads) increases because they are able to provide different output at different times. And, equally important, the indicia that identifies this changing output are themselves changeable because they are located on the display itself, providing an adaptive interplay between output and input. Because keyboards and keypads do not have this ability, they are quickly becoming too expensive, in terms of occupying product real estate, to justify use on many products. However, keyboards and keypads can provide a better user experience (because of the tactile feedback and more intuitive data entry), significantly lower cost than touch technologies, one-handed operation, and in most cases can complete a given task far faster. It is therefore desirable for keypads and keyboards to be adaptive.

### SUMMARY

According to one aspect of the invention, a method of changing the visual appearance of keys of a keypad is provided. The method includes providing an assembled keypad with at least one key having an associated area containing an electrophoretic ink, with the keypad constructed to produce an output associated with the key when an elevated, exposed key surface is manipulated by a user to depress the key relative to the keypad. An electric field is passed through selected regions of the ink in the assembled keypad to alter a visual characteristic of the ink in the selected regions, with the regions selected to form a desired graphic label visible at the exposed surface of the key.

By “ink” we mean a material that can be applied in flowable form to cover a desired area. Some inks are liquid when applied and later cure or solidify. Some inks contain particles suspended in a solution, which may form a binder that solidifies to hold the particles in position in use. Some inks are dry.

Preferably the electrophoretic ink is field-stable. By “field-stable” we mean that the ink maintains a visual appearance induced by an applied field when the field is removed, preferably over a period of days. The E-inks described below have such properties.

In some embodiments, the electric field is passed through the ink by a key cap printing device placed in close proximity to the exposed surface of the keys of the assembled keypad.

In some cases, the electric field is generated by electrically conductive elements within the device. At least one of the electrically conductive elements may be disposed within the key, for example.

According to yet another aspect of the invention, a method of changing the visual appearance of a designated area of a data input device is provided. The method includes passing a field through only selected regions of a field-stable electrophoretic ink in the designated area to alter a visual characteristic of the ink in the selected regions to form a desired graphic label visible within the designated area.

In some cases, the designated area is an area of a digitizer input device. For example, the designated area may be a closed area surrounded by other areas of the digitizer and forming an adaptable button.

In some instances, the designated area is of an exposed surface of a manipulable keycap. For example, the input device may be a keypad and the keycap manipulated by a user to depress the keycap relative to the keypad.

In many cases, the field is an electric field.

In some cases, this electric field is generated by electrically conductive elements, such as graphic-shaped conductors or arrays of transistors within the device. For example, the electrically conductive elements may be disposed within a keycap of a keypad.

In some other cases, the field is passed through the ink by a printer placed in close proximity to the designated area. The printer may be placed in close proximity to exposed surfaces of keycaps of an assembled keypad, for example.

In some embodiments, the visual characteristic is altered as a function of subscriber services selected by a user. For example, the subscriber services may be selected by the user after the data input device is distributed, or the data input device may be informed how to alter the visual characteristic after the device is distributed, such as by activating a resident graphic with an informing signal that may include data describing a graphic previously unknown to the device.

The characteristic may be changed intermittently, such as by a remote location over a cellular or other wireless network or communication system. For example, the field-stable electrophoretic ink may be responsive to signals from a remote location. The intermittent change may enable one-touch access to multiple third parties on a rotating basis. A wireless signal may provide data to identify both a series of graphics and key functions associated with each graphic.

According to another aspect of the invention, a data input device includes an input surface defining a designated input area, and a sensor disposed beneath the designated input area and responsive by manipulation of the input surface by a user to register an input associated with the designated area. The designated input area contains a field-stable electrophoretic ink responsive to passing a field through the ink to alter a visual characteristic of the ink in selected regions to form a desired graphic label visible within the designated area.

In many cases, the device also includes electrically conductive elements disposed on or within the device and adapted to generate the electric field to alter the ink. For example, the designated area may be defined on an exposed surface of a manipulable keycap of a keypad, with at least one of the electrically conductive elements being disposed within the keycap. In some cases, the electrically conductive elements are electrically isolated from each other and disposed to overlap in plan view, with each conductive element shaped to provide a different graphic image visible from the exposed key surface.

In some embodiments, the electrically conductive elements are disposed on a substrate beneath a keycap. The keycap may be formed, for example, of a material that conducts electricity along a single axis, such as a Z-elastomer.

The electrically conductive elements may be, for example, in the form of an active matrix of transistors, such as to create pixelated labels or images.

In some cases, the sensor comprises a capacitive array of conductive traces responsive to location of a finger above the designated area of the input surface.

Another aspect of the invention features the above-described input device in combination with a remote printer placed in close proximity to the designated area and adapted to generate and pass the field through the ink of the device.

According to another aspect of the invention, a method of changing the visual appearance of keys of a keypad is provided. The method includes providing an assembled keypad with at least one key having an elevated, exposed key surface manipulable by a user to depress the key relative to the keypad. Multiple electrically conductive elements are disposed within the key and electrically isolated from each other and disposed to overlap in plan view, with each conductive element shaped to provide a different graphic image visible from the exposed key surface. An electric field is passed through a selected conductive element in the key to form a desired graphic label visible at the exposed surface of the key. Preferably, the method includes selecting from among the graphic images associated with the electrically conductive elements, and passing electric current through a selected conductive element to display its associated graphic image on the key.

Another aspect of the invention features a method of changing the visual appearance of a designated area of a data input device, by placing the device adjacent a printer and passing a field through the designated area of the device to remove a previously applied graphic label from the designated area while forming a new graphic label visible within the designated area.

In some cases the designated area of the device contains an electrophoretic ink responsive to a field applied by the printer. Preferably, the ink is field-stable.

In some embodiments, the input device is an assembled keypad and the printer is placed in close proximity to exposed surfaces of keycaps of the assembled keypad.

According to another aspect of the invention, a method of entering language-specific variants of an alphabetical character through a keypad is provided. The method includes detecting manipulation of a specific key of the keypad and, in response to detecting manipulation, replacing a first language-specific variation of an alphabetic character associated with an alphanumeric key last manipulated before the specific key was manipulated, with a second language-specific variation of an alphabetic character associated with an alphanumeric key.

According to another aspect of the invention, a method of altering format of previously entered text through a keypad is provided. The method includes detecting manipulation of a specific key of the keypad and, in response to detecting manipulation, replacing a displayed, selected text with a differently formatted version of the selected text, according to a predetermined series of formats through which the selected text is cycled upon multiple, sequential manipulations of the specific key.

In some embodiments, the series of formats includes underlined, bold and italicized.

According to another aspect of the invention, a keypad for use by the visually impaired and those of normal eyesight includes a faceplate through which an array of independently manipulable keys extend in a series of rows, and a sequence of tactilely distinguishable features arranged along one side of the array of keys, with each feature corresponding with an associated row of keys.

In some embodiments, each feature consists of a single protrusion of a size unique to the row associated with the feature.

Another aspect of the invention features altering information displayed on an operable, designated data input area of a portable electronic device. The information may include advertisement, location, time or subscription-specific information, etc.

There are several potential benefits and uses for an adaptive keypad printing technology. For example, localization and product customization are important manufacturing considerations. The logistical problems and costs associated with maintaining the proper amount of each variation of product (by language and/or customer) provides significant overhead for a company. Overproduction leaves an inventory of unneeded product while underproduction leaves a void that frustrates customers and loses sales. With this in mind products are designed to allow localization and customization later and later in the manufacturing cycle. One potential advantage of the instant invention is to allow a single product to be manufactured to accommodate localization and product customization needs, eliminating the risk of over production, and greatly increasing the ability of company to quickly and flexibly accommodate the wider variety of customers.

Services and products are increasingly offered on a subscription basis. It can be confusing, however, when certain services cease to be available but are still identified by the product. It is therefore desirable to have an interface that can change dynamically to represent the services to which a user subscribes. That is to say that a technological innovation providing adaptive printed graphics that identifies keycap functionality also facilitates new business models. By way of example: it may be desirable to charge a monthly fee for access to a sophisticated new interface technology. However, not all users will necessarily need to use the sophisticated features provided by the new interface. Without an adaptive keypad interface the manufacturer must choose whether to 1) include the full interface and lose the customers who not wish to pay for the sophisticated features; 2) not include (or not charge for) the sophisticated features, thereby losing that revenue; or 3) turn on the sophisticated features for customers who pay at the cost of having some keys on the product do nothing for customers who are not paying. Adaptive keyboard interface allows the labels of keys to be modified as a function of the level of service desired by the user.

By providing means for keycaps to be adaptively relabeled has a function of the immediate need of the system and/or the user, keyboards and keypads may provide a similar level of interactivity as modern display-based input technologies. Such an advance can significantly enhance the value of the more traditional keypad and keyboard interface, especially because these new interfaces can offer highly-desirable features with respect to cost, user feedback, speed, intuitive operation and one-handed operation.

There are many benefits to being able to modify the labeling of buttons in a device. Some of these benefits enhance the quality of the user experience in using the device and some accrue to the related service and/or content providers. For example, by being able to update and/or modify buttons of a device “on-the-fly” it is possible to: 1) adapt the device to the language of the user; 2) constantly vary the options available to the user at the moment, as a function of the content the user may see or hear at the time, thereby bringing to hardware a level of interactivity currently not available on dedicated physical buttons; and 3) change the market options made available to the user by virtue of advertising dollars which have been spent specifically to control the button images, thereby changing the user's market alternatives.

Electrophoretic inks and other adaptive key labeling means that maintain a graphic image in the absence of applied voltage, field or current are preferred, particularly for applications in which power consumption is critical. Keycaps containing such materials can be constructed to advantageously maintain their appearance during long periods of inactivity, even when batteries powering their associated device have expired. Furthermore, some such keycaps may have their graphics altered by devices not carried upon or within the device upon which the keycap is mounted, such as by a keycap printer into which the device is inserted for keycap graphic initialization or alteration, or by a portion of the device not underlying each individual keycap.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a cross-sectional view through a first embodiment of a visually alterable key of a keypad, and an associated key graphic modification device.

FIG. 2 shows a device with a key graphic printer incorporated into a keypad cover.

FIG. 3 is a cross-sectional view through a second embodiment of a visually alterable key of a keypad, having embedded, pre-defined graphical elements.

FIGS. 3A and 3B are cross-sectional views through third and fourth embodiments, respectively, of visually alterable keys of a keypad, for displaying pixelated graphics.

FIG. 4 is a perspective view of a set of pre-defined graphical elements.

FIG. 5 is a cross-sectional view through a device having a keypad with visually alterable keys.

FIG. 6 shows a plan view schematic of a first combination display and adaptive keyboard element for use in the device of FIG. 5.

FIG. 7 shows a plan view schematic of a second combination display and adaptive keyboard element for use in the device of FIG. 5.

FIG. 8 shows an algorithm for entering letter variants in a pre-selected language.

FIG. 9 shows a keypad with both independent and combination key output, in which alternate rows are identified with reference bumps.

FIG. 10 shows a digitizer input device with visually alterable graphics.

FIG. 11 shows a printed circuit board for the device of FIG. 10, with three different types of visually adaptive button constructions.

FIG. 11A is an enlarged view of one of the buttons of FIG. 11.

FIG. 12 is a cross-sectional view through a digitizer input device constructed with a capacitive sense array, and an associated key graphic modification device.

FIGS. 13A and 14A are cross-sectional views taken along lines 13-13 and 14-14, respectively, in FIG. 10, of an input device having a capacitive sensing array implemented on a transparent screen.

FIGS. 13B and 14B are cross-sectional views taken along lines 13-13 and 14-14, respectively, in FIG. 10, of an input device having an analog-resistive sandwich construction.

FIG. 13C illustrates a first discrete button construction.

FIG. 14C illustrates a second discrete button construction.

FIGS. 15 and 16 show a printed circuit board with a capacitive positioning array, interrupted by a pixelated button constructed as shown in FIG. 13C, and a predefined button 66 constructed as shown in FIG. 14C, respectively.

FIG. 17 is a cross-sectional view through a visually alterable key with a matrix-filled volume containing cholesteric liquid crystals.

FIG. 18 is a flow chart showing a business method in which devices are modified to represent or enable subscriber services added after a device is distributed.

FIG. 19 shows a flow chart of a method to promote different aspects of a third party.

FIG. 20 shows a flow chart of a method to promote different third parties.

Like reference symbols in the various drawings indicate like elements.

### DETAILED DESCRIPTION

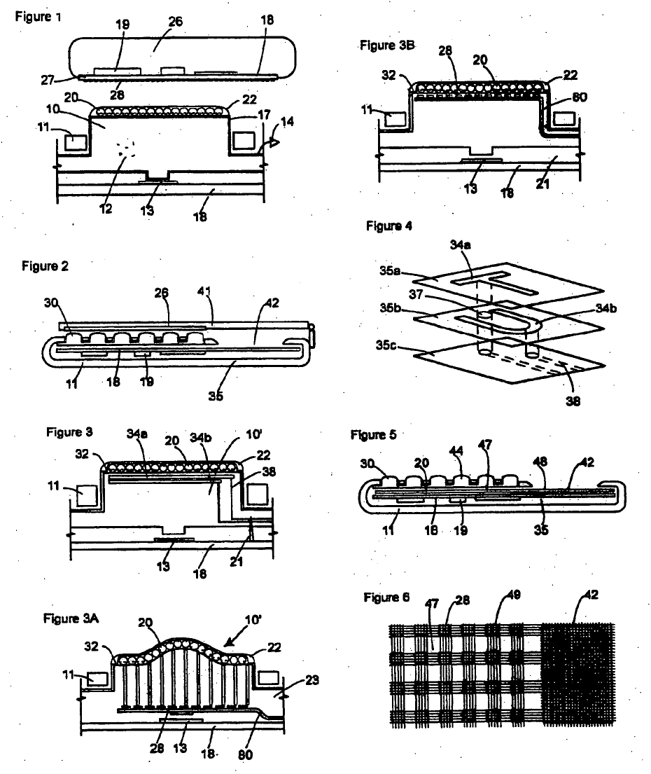

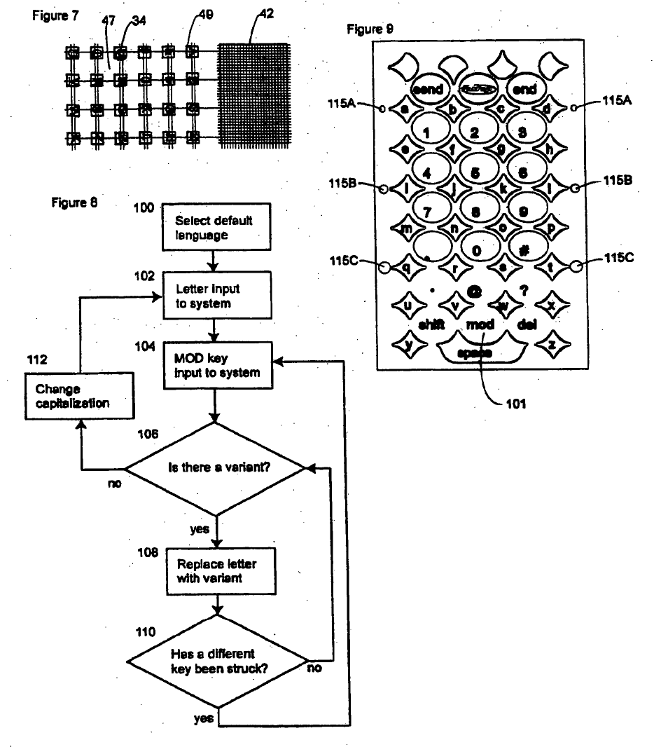

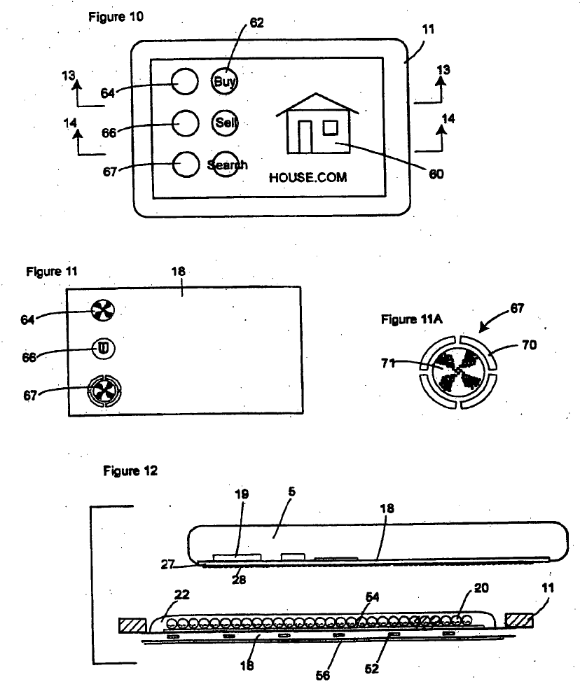

FIG. 1 shows keycap 10 as a representative key of a keyboard 30, as it protrudes through housing 11. When pressed by a user's finger, keycap 10 is displaced toward printed circuit board 18 thereby closing a switch 13 and allowing the user's intent to be registered by the device in which a keyboard 30 is manufactured, such as a telephone, TV remote control, handheld computer, etc. In this embodiment the primary material of keycap 10 is a silicon rubber that has been doped with a conductive fill material 12 which is then, in turn, connected to ground 14. An electrically variable ink 20 is printed in a solid pattern, such as a square, on the exposed surface of keycap 10 and then oversprayed with an optically clear protective layer 22 of material such as polyurethane. Variable ink 20 is not drawn to scale, as the actual spheres tend to range from 25 to 100 microns in diameter. Each sphere contains an opaque, such as white, liquid and some fine particulate of a different color, such as black. The particulate is charged so that it may be moved up or down within the sphere by electophoresis, thereby selectively displaying two distinct colors, such as black or white. In one embodiment, the conductivity of conductive fill material 12 varies with pressure applied, such as provided by Peratech Limited of Darlington, County Durham, England, and the ground plane is nonexistent until established by compressing keypad printer 26 onto keycap 10 with sufficient force to render the conductive fill material 12 conductive. In another embodiment keycap 10 is coated with a conductive coating 17 (such as a carbon-based ink) prior to the application of variable ink 20.

Variable ink 20 may comprise particles dispersed within a suspending, or electrophoretic, fluid, or capsules containing either a cellulosic or gel-like internal phase and a liquid phase, or containing two or more immiscible fluids. Application of electric fields to the electrophoretic ink affects an optical property of the ink, altering the visual appearance of the key cap. Such inks are available from E Ink of Cambridge, Mass., and disclosed in U.S. Pat. Nos. 6,262,706, 5,961,804, and 6,120,588, the contents of all three of which are hereby incorporated by reference in their entirety.

In order to display a character on keycap 10, thereby identifying the character or function that will be provided by the device when the key is pressed by the user, a keypad printer 26 is placed into face-to-face contact with the exposed surfaces of keycap 10. Keypad printer 26 includes a matrix of drive elements 28 on a printed circuit board 18′ (e.g., electrodes or transistors driving electrodes) that provide a controllable voltage level at each element of the matrix 27. One such embodiment of drive elements 28 is to use an individual transistor at each element in the matrix. This and other methods to provide variable voltage levels at each pixel of drive element matrix 27 are known in the art. The voltage levels at each pixel are in reference to the ground plane of keycap 10, providing a “pixelated” image. By temporarily placing keypad printer 26 in face-to-face contact with keycap 10 and varying the voltages of drive elements 28, a graphic image is displayed on the surface of keycap 10 by varying the state of selected regions of ink 20. This approach may be used to simplify the manufacturing process, especially with regard to customization and localization of the product. It is very common for products to be assembled from subassemblies manufactured at distant locations. The keypads for these products will be printed with a variety of different artwork to accommodate the needs of different countries to which the product will be sold. The quantities of each type of keypad must be determined weeks or months in advance of final product assembly, creating the possibility of overproduction or underproduction of any given type of keypads and therefore any given type of products. The methods described herein can enable keypads to be manufactured generically, shipped to the assembly factory while still generic, assembled into the products while still generic, and only then “localized” (i.e., printed with the artwork appropriate for the market into which is sold, such as the alphabet of the local language) prior to being packaged. Keypad printer 26 may be sold with the product so that the customer may reconfigure the keycap identification graphics at will.

Referring to FIG. 2, the keypad printer 26 may be integrally manufactured with the device 35. Keypad printer 26 is built into the door 41 that folds over the keypad 30, allowing a keyboard-based product to adapt to the user's need at the moment. Device 35 is configured to change between being telephone-centric, calculator-centric, calendar-centric, messaging-centric, etc., merely by momentarily closing door 28 and actuating the keypad printing function described above. Likewise, the same technology may be used to alter the language presented by the device, such as from a Latin-based language to Japanese, or to change the keypad layout from QWERTY to AZERTY, as examples. Printed circuit board 18 has electronic components 19 on the backside.

FIG. 3 shows keycap 10 as a representative key of a keyboard 30, as it protrudes through a housing 11 with a clear conductive coating 32, such as indium tin oxide, between variable ink 20 and an over-sprayed, optically clear protective layer 22. Underneath variable ink 20 is a series of predefined graphical elements 34a and 34b (see also FIG. 4) that are electrically conductive and electrically isolated from each other. Conductive printing on a MYLAR substrate has been over-molded within the material of key pad 30. During assembly, connections are made to the printed circuit board 18 by a prong 21 that penetrates the material of the keypad and conductor traces 38.

FIG. 3A shows keycap 10a having a body of a Z-elastomer material 23 that conducts electricity along a single axis, in this case an axis oriented orthogonal to printed circuit board 18, thereby transferring a pattern of voltage differential created by the matrix of drive elements 28, such as an “active” matrix of transistors, disposed at the surface of flexible printed circuit board 80 to a surface at the other end of Z-elastomer 23 disposed proximate the underside of adaptive ink 20. This structure has other uses outside of the field of keycaps. For example, this structure may be employed to provide high-resolution driver voltages to an electrically adaptive ink (used as a display) that is physically displaced from its associated drivers. Advantages are more pronounced in applications in which the adaptive ink 20 is in a non-planar configuration, such as shown here. In an alternate embodiment, flexible printed circuit board 80 may be removed and drive elements 28 disposed upon printed circuit board 18, with the activation of the keys performed by strain gauges in printed circuit board 18, or using the Peratech material discussed above.

FIG. 3B shows a matrix of drive elements 28 disposed on a flexible printed circuit board 80, thereby providing a pixelated character graphic on a keycap 10. Pixelated drive elements 28 can be formed of individual transistors, which may be made by additive or reductive layering processes, including being printed.

FIG. 4 shows a detail of the graphical elements 34 of FIG. 3. The letter “T” 34a is made of a conductive material printed, sputtered or otherwise deposited on nonconductive substrate 35a, such as MYLAR. A hole 37 through nonconductive substrate 35b allows electrical contact between graphical element 34a and conductive traces 38 on the backside of nonconductive substrate 35c. Likewise, graphical element 34b is electrically connected to conductive traces 38. A ground plane (not shown), printed on the back of the lowermost nonconductive substrate, in this case 35b, electrically isolates conductive traces 38. Graphical elements 34a and 34b are therefore electrically isolated from each other, and as voltage is applied to either graphical element 34, conductive traces 38 will not make a ghosted image. Continuous sheets can be formed in this manner and then molded within or on top of the material of a keyboard. This adaptive keyboard interface therefore allows the labels of keys to be modified as a function of the level of service desired by the user.

Keycap 10 may be provided with pre-designated graphical elements, such as characters and icons, by varying the voltage supplied to each of the graphical elements 34, relative to a reference plane located on the opposite side of variable ink 20 from graphical elements 34, as shown in FIG. 3.

FIG. 5 shows an electronic device 35 with a combination display and adaptive keyboard element 48 including display 42 and keypad display elements 47, both made of variable ink 20 and both activated by pixelated drive elements 28. The system controller can therefore modify the graphical elements of keycap 10 in the same manner as it alters the image provided on the display 42. In this embodiment keypad 30 is manufactured with optically transmissive elements 44 displaying the graphical characters composed by conductive ink 20 as the indicia of keycaps 10. In one preferred embodiment a lens effect is provided by the optically transmissive elements 44 such that the indicia presented by each keycap 10 appears to lie at its exposed surface. Device 35 may be a telephone, personal digital assistant, web television remote control, or other such device.

FIG. 6 shows a plan view schematic of the combination display and adaptive keyboard element 48 of FIG. 5. The layout of keypad display elements 47 corresponds with the locations of the keycaps, reducing the number of drive lines and/or transistors required as much of the area is not used, substantially reducing cost and complexity of the keypad. Display elements 47 cover a similar area intended for use as a display 42. Extent boxes 49 identify the extent of adaptive ink 20, superimposed over the grid of pixelated drive elements 28. FIG. 7 shows conductive graphical elements 34 below adaptive ink 20, replacing the pixelated drive elements of the embodiment of FIG. 6.

FIG. 8 shows an algorithm for controlling the text displayed on an electronic device that operates in a plurality of languages. In step 100 a language is pre-selected by the user as a default. In step 102, the user presses a letter key on a keyboard, thereby presenting it to the system. In step 104 the user presses an auxiliary key 101, labeled MOD in FIG. 9. The operation of the MOD key is that the system determines in step 106 whether or not the pre-selected language contains variations to the letter key entered in step 102. For example, if the default language is Spanish and the letter entered is a “C,” there is a variation, namely cedilla, the letter “C” with a small tail underneath. If the language does contain a variation (as with “C” in Spanish) then the system replaces the letter that has been entered in step 102 with the variation identified in step 108. In step 110 the system determines if the user has entered a new letter. If not, and if the default language contains more than one variation to the selected letter, the system returns to step 104. For example, Swedish contains three types of the letter “A,” the first as shown, the second with two dots above, and the third with a small circle above. By pressing the MOD key an additional time the system will display another variant to that specific letter key in that specific language in step 108. When the user strikes a different key the system returns to step 102.

At step 106, if the selected letter does not have a variant in the default language, the system simply returns to step 102. However, in a preferred embodiment the system will perform step 112, which is to alter the capitalization or case of the selected letter. In other words, if the letter was lower case it will be capitalized, and if the letter was upper case the system will make it lower case.

Another functionality of the MOD key applies to the text that has been “selected” or highlighted. Once the user has selected text, a word or phrase, the user may strike the MOD key to cycle through a series of modifications each time the key is struck. For example, the first strike underlines the selected text, the second strike bolds the selected text, the third strike converts the selected text to all upper case, and so forth.

FIG. 9 shows a keypad with both independent and combination key output in which alternate rows are identified with small reference bumps 115. Bumps 115 provide a tactile reference so that a user, particularly the vision-impaired, may identify the location on the keypad with a minimal amount of effort. Bumps 115 may be contiguously molded with the associated keycaps and vary in height, radius or other prominent dimension. In this embodiment, bumps 115a are short, bumps 115b are medium in height, and bumps 115c are the tallest. The user may therefore identify their location on the key to moving their finger to either edge, and evaluating the first bump 115 they find.

FIG. 10 shows a printed image 60, in this case an advertisement for a sponsor named “HOUSE.COM,” that has been permanently printed onto a digitizer input device 50 employing a capacitive position sensing technology, such as is available from Cirque Technology of Salt Lake City, Utah. Such a product may be used as a dedicated Web interface. Another example of a technology that can be employed to implement digitizer input device 50 is an analog-resistive sandwich, such as the input device of the personal digital assistants available from Palm, Inc. Image 60 may alternatively be printed onto an otherwise non-interactive surface. Device 50 includes permanently printed buttons 62, in this case labeled “Buy,” “Sell,” and “Search.” Device 50 also includes adaptable buttons 64, 66 and 67, here each including a “button-shaped” (as opposed to character-shaped or icon-shaped) coating of adaptive ink 20. The adaptive buttons are shown blank, but could contain any representative image. In each case, button structures 64, 66 and 67 are button-like input devices with adaptable identifiers that can be updated and/or modified by the device “on-the-fly” in order to augment the user experience, such as by adapting to 1) the language of the user; 2) options (such as characters for icons) available to the user at the moment, as a function of the content the user may see or hear; or 3) options made available to the user by virtue of advertising dollars spent specifically to control the button images, and thereby the available user alternatives.

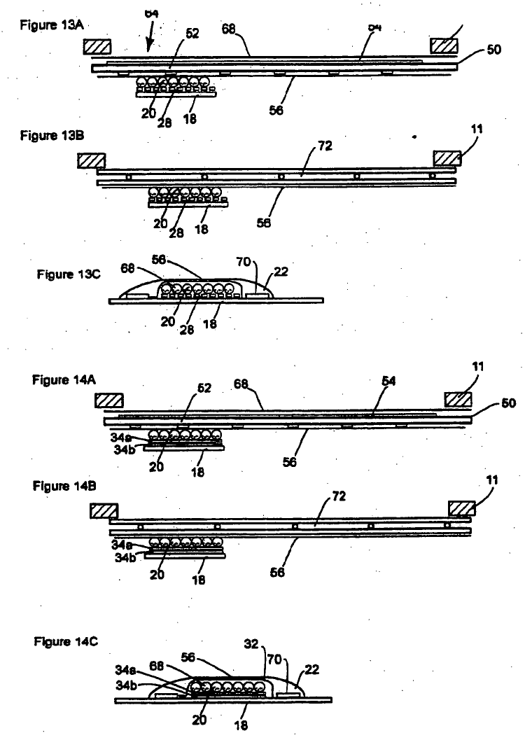

Referring to FIG. 11, buttons 64, 66 and 67 are illustrated with three different constructions, although the buttons of a specific product may certainly be of the same implementation. Pixelated button 64 is structured as shown in FIG. 3B and can produce any image that may be created by the resolution of pixels of the embodiment. Predefined button 66 is constructed as shown in FIG. 3 and can produce images as a function of the drive electrode shape. Cross-sectional views of various embodiments of predefined button 66 are discussed below with respect to FIGS. 14A-14C. Discrete button 67 may have pixelated or predefined features, one of its features being a ring of etched conductors 70 about a central area 71 of the button in which the button image is presented (see FIG. 1A). When parasitic capacitance between conductors 70 on opposite sides of button 67 are approximately equal in at least two orthogonal axes, the system concludes that the user's finger is approximately centered over central area 71. This approach avoids the ground planes of the passive and adaptive ink systems interfering with each other because they are superimposed.

In some cases the graphics presented on adaptive keys such as 64, 66, and 67 are automatically reassigned as a function of the activity of the device, based on keywords, or numbers. One such example is that when a user enters “911” the device automatically places ions for “fire”, “police” and “ambulance” on the adaptive keys. By pressing the key displaying the desired service, the device will call the closest associated organization available, utilizing the location-based knowledge available on next-generation mobile devices. In another example, the user enters “Japanese” on the device and the key icons automatically change to present common categories associated with “Japanese.” The three keys could display: a knife and fork (restaurants); a car (Japanese car dealerships/mechanics); a mouth (language/translation). The user can add a word to the search to access “Japanese furniture” or press the restaurant key to have the adaptive keys present direct access to information about or contact with three local Japanese restaurants whose names appear on the adaptive keys.

Adaptive keys 64, 66, and 67 may be configured as advertising keys. Advertising keys are used as a small billboard that simultaneously promotes awareness of, and provides direct access to, a company and/or its products and services, an embodiment that also entails associated business methods. Advertising keys are particularly useful for hand held devices such as telephones where the screens are small and customers are quickly frustrated by advertising methods that interrupt their activities on the display with un-requested solicitations. Space on advertising keys may be rented or leased, by the minute, hour, or month, with different rates for different times of day. Several advertisers may share the space, alternating their presence intermittently. The time of appearance of the “ads” (small graphics) throughout the day may be associated with the products or services being advertised. The order and timing of the ads may be controlled remotely by a business unit established to perform this function. Note that advertising keys may be gainfully employed on all portable electronic devices, especially mobile phones and hand held computers.

The customer may be provided a subsidy from advertisement revenue for allowing external control of the advertising keys of their portable devices, or the customer may receive a rebate or discount from a service provider each time the customer makes a purchase through his or her advertising keys.

In the embodiment of FIG. 12, printed circuit board 18 contains a capacitive array of orthogonal conductive traces 54 and 52 for detecting the location of a finger above a surface of adaptive ink 20 protected by layer 22. Ground plane 56 of the keypad is temporarily coupled with keypad printer 26 during keycap printing.

FIG. 13A shows another construction, incorporating capacitive positioning sensing technology 50 implemented on glass, utilizing transparent conductors such as indium tin oxide to make horizontal array 52 and vertical array 54. A transparent protective layer 68 protects the oxide traces (or may be integral with them). Ground plane 56 is disposed below both arrays and provides a reference plane for the adaptive ink 20, which may be deposited (printed) directly upon the ground plane. Drive matrix 28 lies below, on printed circuit board 18, and is driven by standard control electronics.

FIG. 13B shows an alternative construction formed with an analog-resistive sandwich 72, with ground plane 56 acting as a reference electrode to adaptive ink 20. Drive matrix 28 lies below, on printed circuit board 18, and is driven by control electronics.

FIG. 13C illustrates a discrete button construction, having a printed circuit board 18 with adaptive ink 20 deposited over driver matrix 28, over a central region surrounded by a ring of conductors 70, to form a discrete button 68. Ground plane 56 covers adaptive ink 20, but not conductors 70. Protective layer 22 protects the device.

FIGS. 14A and 14B are cross-sections taken through the device as constructed in FIGS. 13A and 13B, respectively, but taken through predefined button 66. Predefined graphical elements 34a and 34b are shown disposed above printed circuit board 18 (but may be below or within the circuit board) and are driven by standard control electronics.

FIG. 14C illustrates a discrete button construction, having a printed circuit board 18 with adaptive ink 20 deposited over predefined graphical elements 34a and 34b, over a central region surrounded by a ring of conductors 70, to form a discrete button 68. Ground plane 56 covers adaptive ink 20, but not conductors 70. Protective layer 22 protects the device.

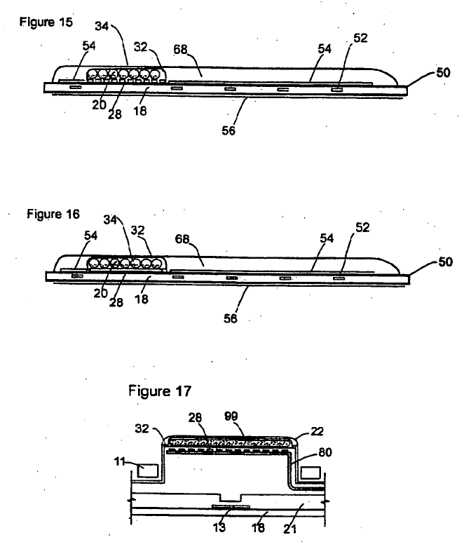

FIG. 15 shows a printed circuit board 18 incorporating capacitive positioning sensing technology as previously described, except that the vertical array 54 of the capacitance grid is now interrupted by pixelated button 64, constructed as shown in FIG. 13C. Interrupting the sense lines of positioning sensing technology 50, and placing matrix 28 directly on the upper surface of printed circuit board 18 provides a low number of layers and manufacturing steps, as well as reducing the need for transparent substrate.

Similarly, FIG. 16 shows a printed circuit board 18 with capacitive positioning sensing technology 50, as previously described, except that vertical array 54 is interrupted by predefined button 66 constructed as shown in FIG. 14C.

Polymer cholesteric liquid crystals (pCLC) are also useful for adaptive key graphics. They may be disposed as flakes within a matrix, such as a silicon oil. As cholesteric liquid crystals (typically a spiral shape) reflect different colors at different angles, a field is employed to locally reorient the crystals to provide a desired graphic pattern. For example, FIG. 17 shows a key of the same structure as that of FIG. 3B, but with a matrix-filled volume 99 containing cholesteric liquid crystals of a spiral shape and approximate length of 40 microns, in place of pixilated drive elements 28. These materials are generally not field-stable, however, and are therefore not preferred for power-sensitive applications.

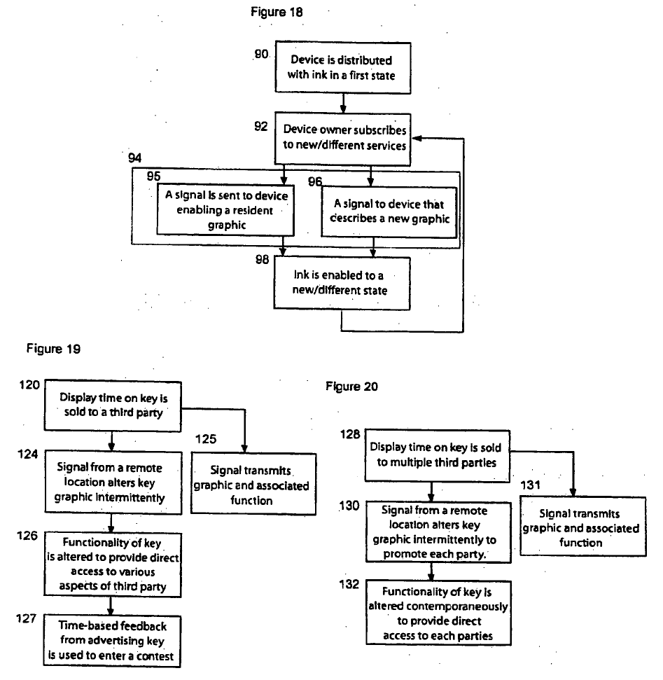

FIG. 18 shows a business method enabled by providing adaptive ink on keycaps, a keyboard, a digitizer input device or other such device. The device is distributed to the user with the ink in a first state (step 90). The device 50 would then be out of control of a manufacturer or service provider, yet the user may subsequently desire: to subscribe to additional functionality, content or service; to cancel an existing service; or to alter the type or level of services already provided. The user may effect this change by phoning a subscriber company, visiting a store, or through the device itself (step 92). In response, an enabling signal is transmitted to the device (step 94) to reflect the change of service. Examples include replacing a set of punctuation marks with “fire”, “run,” jump”, and “dissolve” if one subscribed to a game requiring those features, or using a “MICKEY MOUSE” graphic for the content page if one subscribed to the Disney® channel. In one embodiment the enabling signal activates associated graphics whose characteristics lie resident inside the device (step 95). In another embodiment the enabling signal contains data describing associated graphics (step 96). The signal may be sent wirelessly. In either case, the result is that the graphics that identify the device are altered to allow better access to the new subscriber services (or other functionality) selected by the user after the device was distributed. This change may also include an icon or graphic signifying that the services or functionality have been enabled (step 98).

FIG. 19 shows a flow chart of a method to promote different aspects of a third party and to simultaneously provide direct access to a company and/or its products and services. In this embodiment, a single company licenses the space on an advertising key of the device for an extended period of time and may sequentially display the icons of several of their products or services on the key (step 120). The company may selectively direct which icons appear on the key over the course of time via a signal from a remote location in step 124. In one embodiment, for example, the graphic changes to the advertising key occur contemporaneously with the receipt of this signal. In another embodiment the remote system downloads a series of changes to occur on an intermittent basis, typically with a different function associated with each graphic. In one embodiment the remote system downloads the graphic itself, in step 125. Simultaneous with altering the image on the display, the functionality of the key is altered to reflect the graphic change in step 126. Various aspects of the third party may be promoted in this manner, examples including time-based opportunities, location based opportunities, contests, discounts, content availability, new services, etc, also available in step 126. An example of such a contest (step 127) would be for the company to display a particular graphic on advertising key and whoever presses the key first wins a prize, discount, or points toward an award, etc. In one case advertising keys are implemented with adaptive keys as described above. In another, a liquid crystal display is embedded in a key cap.

FIG. 20 shows a flow chart of a method to promote different companies and to simultaneously provide direct access to the products and services of those companies. First, display time is negotiated with third parties (e.g., rented, leased, sold, bartered, etc.) to provide promotion of and direct access to the products and services of the payees in step 128. In step 130, the device is intermittently provided a signal from a remote location to alter the graphic display upon an advertising key of a portable device, thereby providing small advertisements on a rotating basis. In one example, the graphic changes to the advertising key occur contemporaneously with the receipt of this remote signal. In another case, the remote system downloads a series of changes to occur on an intermittent basis, typically with a different function associated with each graphic. In one instance the remote system downloads the graphic itself, in step 131. Regardless of whether the changes occur contemporaneously with receipt of the signal or sporadically thereafter, the functionality of the key is altered to reflect the graphic change in step 130, thereby providing direct access to particular aspects of each different company. Advertising keys are thus used as a small billboard that promotes awareness of, and provides direct access to, a company and/or its products and services. As such they are particularly useful for hand held devices such as telephones where the screens are small and customers are quickly frustrated by advertising methods that interrupt their activities on the display with un-requested solicitations.

The concepts and features described above are particularly useful in keyboards and keypads in which both individual keys, and combinations of adjacent individual keys, provide unique outputs. Preferred features of such keypad configurations are disclosed in my U.S. patent application Ser. No. 09/862,948, filed May 22, 2001 and entitled “INPUT DEVICES AND THEIR USE,” and corresponding PCT application US01/16461 filed therewith, the entire contents of both of which are incorporated herein by reference as if fully set forth.

A number of embodiments of the invention have been described. Nevertheless, it will be understood that various modifications may be made without departing from the spirit and scope of the invention. Accordingly, other embodiments are within the scope of the following claims.

What is claimed is:

1. A method of changing the visual appearance of a designated area of a data input device, the method comprising
providing a data input device with multiple visible areas, at least one of the areas comprising a designated area containing a field-stable electrophoretic ink; and
passing a field through only selected regions of the field-stable electrophoretic ink in the designated area to alter a visual characteristic of the ink in the selected regions to form a desired graphic label visible within the designated area.

2. The method of claim 1 wherein the designated area is an area of a digitizer input device.

3. The method of claim 2 wherein the designated area is a closed area surrounded by other areas of the digitizer and forms an adaptable button.

4. The method of claim 1 wherein the designated area is of an exposed surface of a manipulable keycap.

5. The method of claim 4 wherein the input device is a keypad, and wherein the keycap is manipulated by a user to depress the keycap relative to the keypad.

6. The method of claim 1 wherein the field is an electric field.

7. The method of claim 6 wherein the electric field is generated by electrically conductive elements within the device.

8. The method of claim 7 wherein the input device is a keypad, the designated area is of an exposed surface of a manipulable keycap of the keypad, and wherein at least one of the electrically conductive elements is disposed within the keycap.

9. The method of claim 7 wherein the electrically conductive elements comprise conductors shaped to form an intended graphic image.

10. The method of claim 7 wherein the electrically conductive elements comprise arrays of transistors.

11. The method of claim 1 wherein the field is passed through the ink by a printer placed in close proximity to the designated area.

12. The method of claim 11 wherein the input device is an assembled keypad and the printer is placed in close proximity to exposed surfaces of keycaps of the assembled keypad.

13. The method of claim 1 wherein the visual characteristic is altered as a function of subscriber services selected by a user.

14. The method of claim 13 wherein the visual characteristic is altered as a function of subscriber services selected with the data input device

15. The method of claim 1 wherein the visual characteristic is altered intermittently.

16. The method of claim 15 wherein the visual characteristic is altered intermittently to provide a series of graphics identifying third parties accessible by manipulating an input region of the device corresponding to the designated area.

17. The method of claim 1 further comprising sending a signal to the input device to trigger altering of the visual characteristic.

18. The method of claim 17 wherein the signal is sent from a remote location over a cellular or other wireless network or communication system.

19. The method of claim 18 wherein the signal provides data to identify both a series of graphics and key functions associated with each graphic.

20. The method of claim 17 wherein the signal activates a graphic already resident in memory within the device.

21. The method of claim 17 wherein the signal includes data describing a graphic previously unknown to the device.

22. The method of claim 1 wherein the desired graphic label corresponds to a language-specific variant of an alphabetical character.

23. The method of claim 22 further comprising detecting manipulation of a specific key of the keypad and, in response to detecting said manipulation, replacing a first language-specific variation of an alphabetic character associated with an alphanumeric key last manipulated before the specific key was manipulated, with a second language-specific variation of an alphabetic character associated with an alphanumeric key.

24. A data input device comprising
an input surface defining a designated input area; and
a sensor disposed beneath the designated input area and responsive by manipulation of the input surface by a user to register an input associated with the designated area;
wherein the designated input area contains a field-stable electrophoretic ink responsive to passing a field therethrough to alter a visual characteristic of the ink in selected regions to form a desired graphic label visible within the designated area.

25. The input device of claim 24 in the form of a digitizer.

26. The input device of claim 25 wherein the designated area is a closed area surrounded by other input areas of the digitizer and forms an adaptable button.

27. The input device of claim 24 wherein the designated input area is of an exposed surface of a manipulable keycap.

28. The input device of claim 27 in the form of a keypad, and wherein the keycap is manipulated by a user to depress the keycap relative to the keypad.

29. The input device of claim 24 wherein the ink is responsive to passing an electric field therethrough.

30. The input device of claim 29 further comprising electrically conductive elements disposed within the device and adapted to generate the electric field to alter the ink.

31. The input device of claim 30 in the form of a keypad with the designated area defined on an exposed surface of a manipulable keycap of the keypad, wherein at least one of the electrically conductive elements is disposed within the keycap.

32. The input device of claim 31 wherein the electrically conductive elements are disposed within the keycap and electrically isolated from each other and disposed to overlap in plan view, with each conductive element shaped to provide a different graphic image visible from the exposed key surface.

33. The input device of claim 30 in the form of a keypad with the designated area defined on an exposed surface of a manipulable keycap of the keypad, and wherein the electrically conductive elements are disposed on a substrate beneath the keycap.

34. The input device of claim 33 wherein the keycap is formed of a material that conducts electricity along a single axis.

35. The input device of claim 30 wherein the electrically conductive elements form an active matrix of transistors.

36. The input device of claim 24 wherein the sensor comprises a capacitive array of conductive traces responsive to location of a finger above the designated area of the input surface.

37. The input device of claim 24 in combination with a remote printer placed in close proximity to the designated area and adapted to generate and pass the field through the ink of the device.

38. A method of changing the visual appearance of keys of a keypad, the method comprising
providing an assembled keypad with at least one key having an elevated, exposed key surface manipulable by a user to depress the key relative to the keypad, the key containing multiple electrically conductive elements electrically isolated from each other and disposed to overlap in plan view, with each conductive element shaped to provide a different graphic image visible from the exposed key surface;
selecting from among the graphic images associated with the electrically conductive elements; and
passing an electric field through a selected conductive element in the key to form a desired graphic label visible at the exposed surface of the key.

39. A method of changing the visual appearance of a designated area of a data input device, the method comprising
placing the device adjacent a printer capable of generating a field; and
passing a field from the printer through the designated area of the device to remove a previously applied graphic label from the designated area while forming a new graphic label visible within the designated area.

40. The method of claim 39 wherein the designated area of the device contains an electrophoretic ink responsive to the field applied by the printer.

41. The method of claim 40 wherein the ink is field-stable.

42. The method of claim 39 wherein the input device is an assembled keypad and wherein the printer is placed in close proximity to exposed surfaces of keycaps of the assembled keypad.

43. A method of altering format of previously entered text through a keypad, the method including
detecting manipulation of a specific key of the keypad; and,
in response to detecting manipulation, replacing a displayed, selected text with a differently formatted version of the selected text, according to a predetermined series of formats through which the selected text is cycled upon multiple, sequential manipulations of the specific key.

44. The method of claim 43 wherein the series of formats includes underlined, bold and italicized.

45. A method of altering information displayed on an operable, designated data input area of a portable electronic device, the method comprising
providing a data input device with multiple data input areas having visible labels associated with the input areas; and
transmitting a signal to the input device from a remote location to alter the visible label of at least one of the data input areas of the device in response to the signal.

46. The method of claim 45 wherein the data input area of the altered label contains a field-stable electrophoretic ink, the signal causing a field to be passed through selected regions of the field-stable electrophoretic ink to alter a visual characteristic of the ink to alter the graphic label.

47. The method of claim 45 wherein the altered visible label contains one of advertisement, location, time or subscription-specific information.

48. The method of claim 45 wherein the signal is transmitted to the input device over a cellular or other wireless network or communication system.

49. The method of claim 45 wherein the label is altered as a function of subscriber services selected by a user.

50. The method of claim 45 further comprising, prior to transmitting said signal, receiving a label-triggering signal from the data input device.

51. The method of claim 45 wherein the label is altered intermittently.

52. The method of claim 51 wherein the label is altered intermittently to provide a series of graphics identifying third parties accessible by manipulating the data input area associated with the label.

53. The method of claim 45 wherein the transmitted signal provides data to identify both a series of graphics and key functions associated with each graphic.

54. The method of claim 45 wherein the transmitted signal activates a graphic already resident in memory within the device.

55. The method of claim 45 wherein the signal includes data describing a graphic previously unknown to the device.

56. The method of claim 45 wherein the data input areas are exposed surfaces of manipulable keycaps.

57. The method of claim 56 wherein the input device is a keypad, and wherein the keycaps are manipulated by a user to depress the keycaps relative to the keypad.
